(19) United States
(12) Patent Application Publication
(10) Pub. No.: US 2013/0276761 A1
(43) Pub. Date: Oct. 24, 2013

(54) VARIABLE-COMPRESSION ENGINE ASSEMBLY

(71) Applicants: Patrick C. HO, Hilton, NY (US); Michael M. VACANTI, Alexander, NY (US)

(72) Inventors: Patrick C. HO, Hilton, NY (US); Michael M. VACANTI, Alexander, NY (US)

(21) Appl. No.: 13/454,434

(22) Filed: Apr. 24, 2012

(51) Int. Cl. F02B 75/28; F02B 75/32

(52) U.S. Cl. 123/51 R; 123/197.1

(57) ABSTRACT

Variable-compression engine assemblies with an internal combustion device and a flywheel are presented herein. An engine assembly is disclosed which includes an output shaft and a flywheel, which includes a variable cam surface and is slidably mounted onto the output shaft and rotatable about a flywheel axis. Also included is an internal combustion device with a piston that is movable along a central axis in a cycle between refracted and extended positions. The piston engages the variable cam surface, and the central axis of the piston is spaced from the flywheel axis. The cycle includes a power stroke when the piston moves from the retracted position to the extended position whereby the piston presses against the variable cam surface and thereby rotates the flywheel, and a compression stroke when the piston moves from the extended position to the retracted position responsive to the variable cam surface.

### TECHNICAL FIELD

The present disclosure relates generally to engines, and more particularly to variable-compression internal combustion engine assemblies.

### BACKGROUND

Internal combustion engines (often referred to by the acronym “ICE”) convert chemical energy into mechanical energy typically through the combustion of a petroleum-based fossil fuel which is mixed with an oxidizer, such as air, in a combustion chamber. The resultant exothermic reaction of fuel and oxidizer creates gases of high temperature and pressure which expand to move a mechanical component. The two most common forms of internal combustion engines are the reciprocating engine, such as the modern-day automobile engine, and the continuous combustion engine, which includes jet engines and gas turbines. Reciprocating internal combustion engines include, for example, multi-stroke piston engines, and other well-known engine types.

In reciprocating-piston ICE designs, one or more pistons are used to drive a rotatable crankshaft. Each piston is slidably disposed inside a cylinder and connected to the crankshaft by a connecting rod. The stroke of the reciprocating assembly is determined by the offset of the crankshaft's connecting rod journal known as the crankshaft “throw.” This design can lead to numerous limitations and deficiencies. For instance, the crankshaft always generates the same stroke pattern for piston travel. It is a uniform motion and cannot be altered. Thus, the respective duration of intake strokes, exhaust strokes, compression strokes and power strokes, e.g., in a four-stroke ICE configuration, typically must coincide and are invariable. This is true of almost any engine utilizing a crankshaft no mater its size and number of cylinders.

Power is typically produced by filling each engine cylinder with an air-fuel mixture and inducing combustion of the mixture to generate heat and expansion to propel the pistons and, thereby, rotating the crankshaft. Filling the cylinder with an air-fuel mixture requires duration of time. Power produced by the ICE therefore has a direct correlation to the volumetric efficiency (VE) of the intake cycle. However, the time for the intake cycle is usually dictated by crankshaft speed and geometry; thus, volumetric efficiency is often compromised.

Achieving complete air-fuel mixture combustion, known as stoichiometric combustion, also takes time. To compensate for the restricted combustion interval, many conventional multi-stroke ICE designs advanced the ignition timing ahead of the piston achieving top dead center (TDC) during a compression stroke. The faster the speed of rotation, the more advancement of timing is used. This, in turn, wastes energy since additional power is required (during the compression stroke) to compress the expanding gases produced during the onset of the combustion process. This results in generated energy being used inefficiently. Due to the restrictions and other environment variables, stoichiometric combustion is briefly or never achieved.

A method commonly used to create additional compression time is to lengthen the connecting rod, thereby allowing the piston to “park” at top dead center for a longer than normal duration of time. However, there is a limitation to the length of the connecting rod used since longer rods will expand the physical size and weight of the engine. As such, additional time is inherently restricted.

The power output of conventional ICE designs is directly proportional to the work generated by the expansion of the combusted air-fuel mixture. Since the time within the power stroke to transfer power to the crankshaft is directly proportional to the rotational speed, unused heat and expansible energy are channeled out when the exhaust valve opens near the end of the power stroke and throughout the exhaust stroke as the piston approaches bottom dead center (BDC) and travels back to TDC. This leads to additional wasted energy.

As noted above, the piston within a traditional reciprocating-piston engine is driven up and down in the cylinder by the connecting rod which is directly connected to the connecting rod journal of the crankshaft. The 360-degree rotation of the crankshaft moves the piston forward from BDC to TDC and then back to BDC. Each cycle of reciprocation—e.g., piston movement to-and-from TDC, is known as the engine “stroke.”

During the second cycle of a four-cycle (or four-stroke) engine, the intake and exhaust valves for the specific cylinder are closed and the piston moves forward through its stroke distance and compresses the working volume of the cylinder into a chamber at the top of the cylinder. The change in combustion chamber volume created by the piston stroke is expressed numerically in a ratio, which is known as the Compression Ratio (CR). Compression Ratio can be expressed generally by the following formula:

CR=Cylinder volume when piston at BDC(A)/Cylinder volume when piston at TDC(B)

Fixed Compression Stroke distance is determined by the offset of the connecting rod journal which is shaped into the crankshaft profile. The offset is known as the crankshaft “throw”. The throw is a fixed distance and cannot be altered; thus, the stroke distance is fixed and cannot be altered. This directly affects the intake, compression, power and exhaust cycles limiting the operating parameters of the engine.

There are limited prior art designs where a piston interacts directly with an undulating flywheel surface. One design that arguably bears some relationship to an engine of this type is disclosed in U.S. Pat. No. 3,745,887, which issued to George Striegl on Jul. 17, 1973. Striegl discloses a reciprocating engine with pistons that interact with a hollow cylindrical “rotor” having a cam edge. Each piston of the Striegl device is nested in its own individual hollow rotor, with each rotor connected by an output/drive shaft to a flywheel. All of these elements are in axial alignment. However, there is nothing in Striegl that has off-axis pistons interacting with the surface of a flywheel. Nor, does Striegl provide the additional design flexibility necessary for the truly efficient functioning of piston-based internal combustion engines.

Based on the foregoing limitations and deficiencies associated with conventional reciprocating-piston ICE engines, including those that utilize flywheels, there is a continuing need for additional flexibility in designing the pattern, speed, and timing for various strokes in piston-based internal combustion engines.

### SUMMARY

Aspects of this disclosure are directed to an innovative engine design that incorporates opposing pistons which are located within the same cylinder and driven towards each other by two undulating flywheels at opposite ends of the engine assembly. Each flywheel has a precise cam-like surface profile that controls stroke height and duration interval of piston travel throughout the engines cycles. When both pistons are at TDC, the volume between the piston tops creates the combustion chamber. This configuration eliminates the need for a conventional crankshaft.

Rotation of the two flywheels in the above example can be held in synchronization by a main shaft that runs the length of the engine. In some embodiments, the main shaft has a key or external splines that mate with a complementary center hole in each flywheel which has a matching key slot or internal splines. This allows the combustion force applied to the flywheels to be transferred to the main shaft, which can also serve as the output shaft for the engine. The splined engagement also allows the flywheels freedom to move back-and-forth along the length of the main shaft.

By utilizing hydraulic, pneumatic, and/or mechanical forces applied to or removed from the flywheel—e.g., a surface of the flywheel which is opposite the cam-like surface for the piston—the flywheel can be selectively moved forward and/or backward along the main shaft. This results in the combustion chamber volume changing and, thus, a changing compression ratio. In real time and precisely controlled during engine operation, this innovative engine design has true variable compression.

Some advantages of the disclosed cam-like flywheel surfaces derive from the fact that the surface can be shaped and formed so as to provide specific engine cycle features desired by the designer. For instance, it provides extraordinary flexibility in adjusting the duration of the intake/exhaust cycle, the duration of the combustion/power cycle, the intake stroke pattern (e.g., to maximize cylinder fill volumetric efficiency), the power stroke pattern (e.g., to maximize transfer of power from the piston to the flywheel), and to park the piston at TDC during power stroke for a longer duration to achieve stoichiometric combustion. In comparison, the conventional crankshaft, piston, and connecting rod arrangement of traditional ICE assemblies provides limited design flexibility. In the conventional assembly, the offset shaped into the crankshaft fixes duration within the 360-degree crankshaft rotation. And, TDC and BDC durations can be only minimally altered through the use of different length connecting rods at a given crankshaft offset distance. Additional benefits associated with cam-like flywheel surfaces and expansible-chamber engines are disclosed in commonly owned U.S. Pat. No. 7,040,262, to Patrick C. Ho, which is incorporated herein by reference in its entirety and for all purposes.

The variable compression features disclosed herein provide controllable compression ratio, increased combustion efficiency, controllable power output and combustion characteristics and improved emission performance of the engine. By way of example, variable compression allows the engine to adapt to initial startup conditions and then maintain correct parameters during normal operation under various load conditions. It also allows the engine to adapt to various compositions of fuel types, quality, and combustion characteristics. Moreover, the CR can be continuously adjusted in real-time during engine operation to compensate for varying engine load, temperature, and operating changes to achieve optimal performance.

According to aspects of the present disclosure, an engine assembly is presented. The engine assembly includes an output shaft and a flywheel with a variable cam surface. The flywheel is slidably mounted onto the output shaft and rotatable about a flywheel axis. The engine assembly also includes an internal combustion device with a piston that is movable along a central axis in a cycle between retracted and extended positions. The piston engages the variable cam surface. The central axis of the piston is spaced from the flywheel axis. The cycle includes a power stroke when the piston moves from the retracted position to the extended position whereby the piston presses against the variable cam surface and thereby rotates the flywheel, and a compression stroke when the piston moves from the extended position to the retracted position responsive to the variable cam surface.

Other aspects of the present disclosure are directed to a variable-compression engine assembly. The variable-compression engine assembly includes an output shaft that is rotatable about a common axis, and a flywheel with a variable cam surface that is mounted onto the output shaft for common rotation therewith. The flywheel is rotatable about the common axis and selectively slidable on the output shaft along the common axis. The variable-compression engine assembly also includes an internal combustion device with a piston disposed in a cylinder. The piston is movable along a central axis in a cycle between retracted and extended positions. An outboard end of the piston engages the variable cam surface. The central axis of the piston is radially spaced from the common axis. A prime mover is configured to move the flywheel longitudinally along the output shaft to thereby selectively change a compression ratio of the internal combustion device. The cycle includes a power stroke when the piston moves from the retracted position to the extended position whereby the piston presses against the variable cam surface and thereby rotates the flywheel, and a compression stroke when the piston is moved by the flywheel from the extended position to the retracted position responsive to the variable cam surface.

Additional aspects of this disclosure are directed to an engine assembly. This engine assembly includes an output shaft, first and second flywheels and an internal combustion device. The output shaft is rotatable about a common axis. The first flywheel has a first variable cam surface and is slidably mounted onto the output shaft and rotatable about the common axis. The second flywheel is coaxial with and spaced from the first flywheel. The second flywheel has a second variable cam surface that is facing the first variable cam surface. The second flywheel is mounted onto the output shaft and rotatable about the same common axis as the first flywheel and output shaft. The internal combustion device is disposed between the first and second flywheels. The internal combustion device has first and second opposing pistons each of which is movable along a central axis in a cycle between respective retracted and extended positions. The central axis of the pistons is spaced from the common axis of the output shaft and flywheels. The first piston engages the first variable cam surface whereas the second piston engages the second variable cam surface. Each cycle includes a power stroke, whereat a respective one of the pistons moves from respective retracted to extended positions whereby the respective piston presses against a respective one of the variable cam surfaces and thereby rotates a respective one of the flywheels, and a compression stroke, whereat the respective piston moves from respective extended to retracted positions responsive to the respective variable cam surface.

The above summary is not intended to represent each embodiment or every aspect of the present disclosure. Rather, the foregoing summary merely provides an exemplification of some of the novel and inventive features included herein. The above features and advantages, and other features and advantages of the present disclosure, will be readily apparent from the following detailed description of the embodiments and best modes for carrying out the present invention when taken in connection with the accompanying drawings and appended claims.

### BRIEF DESCRIPTION OF THE DRAWINGS

FIG. 1 is a perspective-view illustration of a representative variable-compression engine assembly with an internal combustion engine and opposing flywheel assemblies in accordance with aspects of the present disclosure.

FIG. 2 is an enlarged perspective-view illustration of a portion of the main shaft and one of the flywheels of FIG. 1.

FIG. 3 is a side-view illustration of the representative engine assembly of FIG. 1 taken in partial cross-section along line 3-3 to show the engine assembly at high compression.

FIG. 4 is an alternative side-view illustration of the representative engine assembly of FIG. 1 also taken in partial cross-section to show the engine assembly at low compression.

While the present disclosure is susceptible to various modifications and alternative forms, specific embodiments are shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

This invention is susceptible of embodiment in many different forms; herein, there are shown in the drawings and described in detail preferred embodiments of the invention with the understanding that the present disclosure is to be considered as an exemplification of the principles of the invention and is not intended to limit the broad aspects of the invention to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the word “all” means “any and all”; the word “any” means “any and all”; and the words “including” and “comprising” mean “including without limitation.” Moreover, words of approximation, such as “about,” “almost,” “substantially,” “approximately,” and the like, can be used herein in the sense of “at, near, or nearly at,” or “within 3-5% of,” or “within acceptable manufacturing tolerances,” or any logical combination thereof, for example.

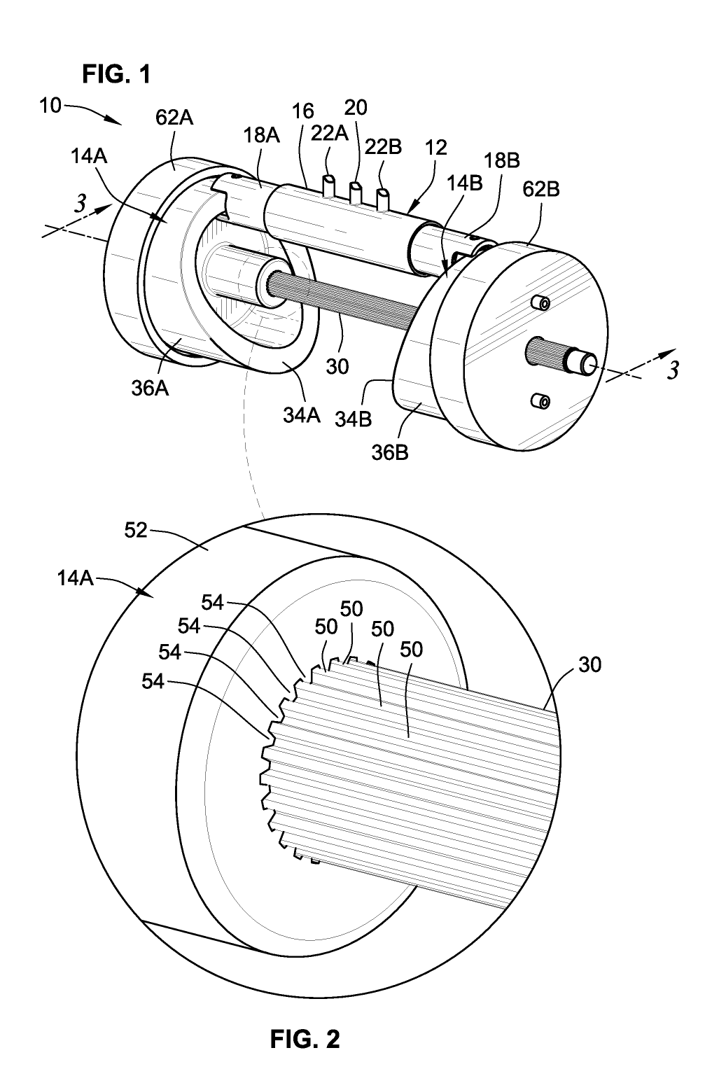

Referring now to the drawings, wherein like reference numerals are used to refer to the same or similar components throughout the several views, there is shown in FIG. 1 a representative variable-compression engine assembly, designated generally at 10, with an internal combustion device 12 disposed between opposing flywheel assemblies 14A and 14B. It should be readily understood that the engine assembly 10 illustrated herein is merely provided as an exemplary application by which the various inventive aspects and features of this disclosure may be utilized. Moreover, only selected components of the engine assembly 10 have been shown and will be described in additional detail hereinbelow. Nevertheless, the engine assemblies discussed herein can include numerous additional and alternative components, such as fuel and exhaust valves, one or more cam shafts, spark plugs, a throttle body, an exhaust manifold, sensor assemblies, and other well-known peripheral components, for example. Seeing as these components are well known in the art, they will not be described in further detail. Finally, the drawings presented herein are not necessarily to scale and are provided purely for instructional purposes. Thus, the individual and relative dimensions shown in the drawings are not to be considered limiting.

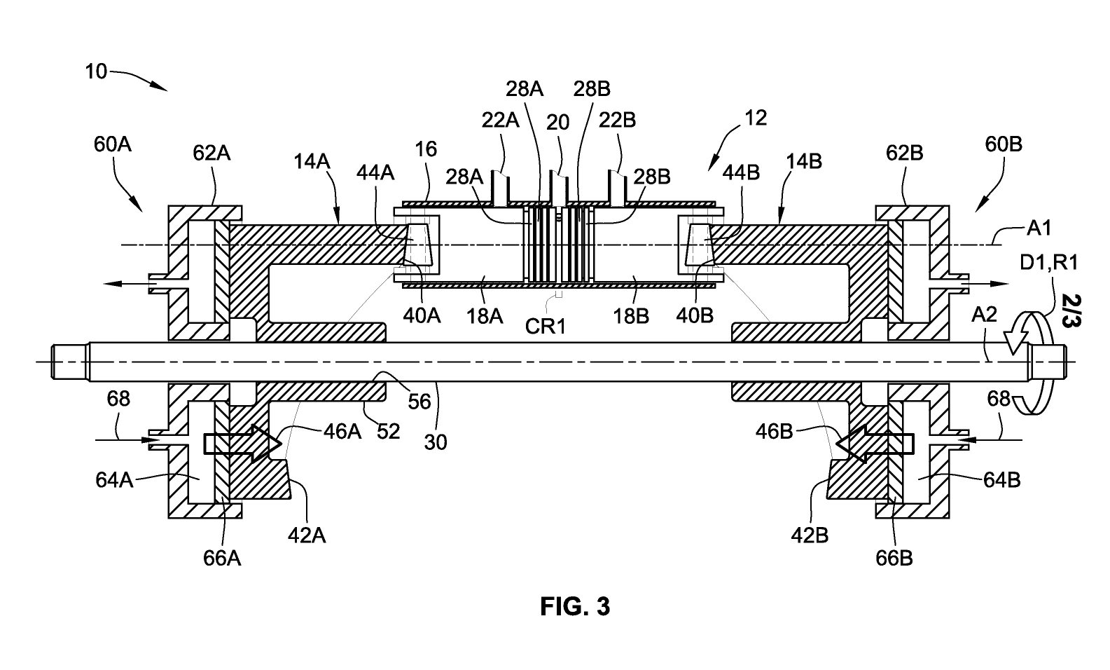

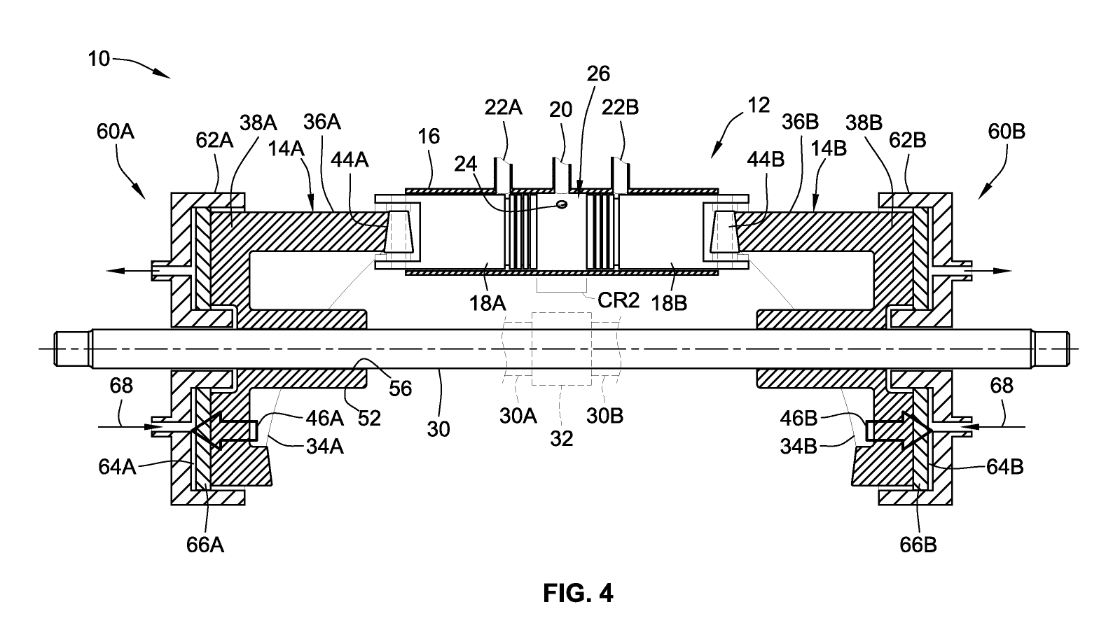

The internal combustion device 12, as shown, is an expansible chamber device that includes an elongated hollow cylinder 16 within which is housed a first (left) piston 18A in opposing spaced relation to a second (right) piston 18B, as best seen in the cross-sectional views of FIGS. 3 and 4. While the internal combustion device 12 is illustrated with respect to a single cylinder 16 housing two pistons 18A, 18B, those skilled in the art will recognize that any number of cylinders and/or pistons may be incorporated into the engine assembly 10. The pistons 18A, 18B are movable in a “cycle” toward and away from each other along a central axis A1 between respective retracted positions (e.g., FIG. 1) and extended positions (e.g., FIG. 3). In at least some embodiments, the central axis A1 is common to both pistons 18A, 18B and corresponds to the longitudinal central axis of the cylinder 16. The volume between the tops of the reciprocating pistons 18A, 18B, e.g. when both at top dead center (TDC), defines a combustion chamber 26. Each piston 18A, 18B may be provided with one or more elastomeric piston rings, some of which are designated as 28A and 28B in FIG. 3, respectively, for sealing the combustion chamber 26.

In the embodiment shown, the cylinder 16 includes four ports: an air inlet port 20, a first (left) exhaust port 22A, a second (right) exhaust port 22B, and a fuel inlet port 24 (see FIG. 4). It is envisioned that the cylinder 16 may include greater or fewer ports than those shown in the drawings without departing from the intended scope and spirit of the present disclosure. Each port may be provided with a respective valve (not shown) for regulating the flow of fluids, such as fuel vapor, combustion gases, oxidizers, etc., therethrough. For two-stroke applications, the exhaust ports 22A, 22B can be positioned as shown, whereas it may be desirable that these ports 22A, 22B be located closer to the center of the cylinder 16 near the air and fuel inlet ports 20, 24 in four-stroke applications. For gasoline applications, it may be desirable that the fuel inlet port 24 be used for both fuel injection and spark plug ignition. By way of comparison, some diesel applications may use the fuel inlet port 24 solely for fuel. From the foregoing description it should be readily apparent that the engine assembly 10 is similarly applicable in spark ignition (SI) configurations, compression ignition (CI) configurations, or both (e.g., multi-fueled).

Rotation of the two flywheels 14A and 14B can be held in synchronization by a main shaft 30 (also referred to herein as “output shaft”) that runs the length of the engine assembly 10. The first flywheel 14A of the illustrated embodiment is coaxial with and spaced from the second flywheel 14B. In this regard, both flywheels 14A, 14B are mounted on, concentrically aligned with, and circumscribe the main shaft 30 to rotate about a common axis A2 (also referred to herein as “flywheel axis”). The flywheels axis A2, as shown, is generally parallel to and radially spaced from the central axis A1 of the pistons 18A, 18B.

In the illustrated embodiment, both flywheels 14A, 14B are mounted onto the output shaft 30 for common rotation therewith. That is, the output shaft 30 and flywheels 14A, 14B all rotate in the same direction Dl and, in at least some embodiments, at the same rotational velocity R1. Alternative designs could have two main shafts (shown schematically at 30A and 30B in FIG. 4) that are connected together by a gear box or planetary gear set (shown schematically at 32), which enables the flywheels 14A, 14B to rotate in opposite directions while remaining timed with each other. In yet another optional configuration, one flywheel can be coupled directly to the output shaft 30, while the other flywheel is connected to the shaft 30 by a gear box or planetary gear set. This arrangement allows the flywheels 14A, 14B to turn in opposite directions and at same speeds, yet act in the same direction on the output shaft 30.

With reference back to FIG. 1, the first flywheel 14A has first variable cam surface 34A and the second flywheel 14B has a second variable cam surface 34B that is spaced from and facing the first variable cam surface 34A. In the illustrated embodiment, the variable cam surfaces 34A, 34B are structurally identical non-repeating waveforms with a single peak 40A and 40B and a single valley 42A and 42B, respectively (see FIG. 3). The flywheels 14A, 14B include respective annular rims 36A and 36B, respectively, that project towards the internal combustion device 12 from a disk-shaped base 38A and 38B, respectively. Each variable cam surface 34A, 34B extends continuously around the distal edge of the annular rim 36A, 36B. As best seen in FIGS. 3 and 4, each annular rim 36A, 36B has a variable height that provides its respective variable cam surface 34A, 34B with the single peak 40A, 40B and single valley 42A, 42B. With this configuration, the flywheels 14A, 14B make one full rotation (i.e., rotate at least approximately 360 degrees) during each piston cycle. Optional configurations may include variable cam surfaces with differing shapes (e.g., repeating (sinusoidal) waveform patterns) and/or dimensions (e.g., lengths, widths and angles) than what is shown in the drawings.

According to the example shown in the drawings, the first piston 18A engages the first variable cam surface 34A while the second piston 18B engages the second variable cam surface 34B but not the first cam surface 34A. FIGS. 3 and 4 portray each piston 18A, 18B with a cam roller 44A and 44B, respectively, that is rotatably mounted to its outboard end. In the illustrated embodiment, the cam rollers 44A, 44B are tapered rollers which are typically able to support both radial and axial loads. To accommodate the frustoconical shape of the cam roller 44A, 44B, and ensure consistent contact, the mating cam surfaces 34A, 34B are obliquely angled with respect to the flywheels axis A2. The angled interface between the cam rollers 44A, 44B and the can surfaces 34A, 34B also helps to ensure that each roller 44A, 44B rotates at a uniform speed. It is also envisioned that the cam rollers 44A, 44B be replaced with cylindrical rollers, spherical rollers, or bearing assemblies, for example.

At least one, and in the illustrated embodiments both flywheels 14A, 14B are slidably mounted onto the output shaft 30. Some configurations allow the flywheels 14A, 14B to slide rectilinearly back-and-forth on the output shaft 30 along the common axis A2 such that the flywheels 14A, 14B can translate along the longitudinal length of the shaft 30 towards each other and the internal combustion device 12, as illustrated by arrows 46A and 46B in FIG. 3, and away from each other and the internal combustion device 12, as illustrated by arrows 48A and 48B in FIG. 4. FIG. 2 is an enlarged perspective-view illustration of a portion of the main shaft 30 and the first flywheel 14A showing the shaft 30 splined to the flywheel 14A. In particular, the main shaft 30 has a plurality of external splines (or “teeth”), some of which are called out at 50 in FIG. 2, that project from and are circumferentially spaced about the outer periphery of the shaft 30. The main shaft 30 passes through a complementary center hole 56 (FIG. 3) in a hub portion 52 of the flywheel 18A such that the external splines 50 interleave and mesh with matching internal splines, some of which are called out at 54 in FIG. 2, that project from the inner periphery of the center hole 56. The main shaft 30 can be splined to the second flywheel 14B in the same manner. It is also envisioned that the engine assembly 10 utilize alternate means for slidably engaging the flywheels 14A, 14B with the main shaft 30, such as a key-type mechanical coupling (known as a “keyed joint”). Either option will allow the flywheels 14A, 14B to move back-and-forth on the main shaft 30 and also rotate simultaneously with the shaft 30 and each other.

Altering the position of one or more of the flywheels 14A, 14B relative to the internal combustion device 12 operates to change the compression ratio of the internal combustion device 12. Because the pistons 18A, 18B ride on the variable cam surfaces 34A, 34B of the flywheels 14A, 14B, they too will move back-and-forth with the flywheels 14A, 14B. As a result, the space between the tops of the opposing pistons 18A, 18B at TDC, which is the combustion chamber 26 for the ICE assembly 16, will likewise change in volume relative to flywheel position. The change to a larger or smaller volume results in lower or higher compression ratio, respectively. By way of non-limiting example, the first flywheel 14A can be moved on the output shaft 30 from a first longitudinal position (e.g., FIG. 3) to a second longitudinal position (e.g., FIG. 4), and back (or anywhere therebetween). The internal combustion device 12 has a first “high” compression ratio CR1 when the flywheel 14A is located at the first longitudinal position (e.g., FIG. 3) and a second “low” compression ratio CR2, which is less than the first compression ratio CR1, when the flywheel 14A is located at the second longitudinal position (e.g., FIG. 4). Such changeability of compression ratio constitutes “variable compression”. The numerical CR value changes in correlation to combustion chamber size. Being able to incorporate variable compression creates more control of the engine's operating dynamics. The variable compression advancement will provide greater efficiency and broaden the scope of the engine's capability.

The positional changes of each flywheel 14A, 14B can be effectuated in “real time”—i.e., while the engine assembly 10 is in operation. For the flywheels 14A, 14B to move back and forth along the main shaft 30, a force is applied to or removed from the flywheels 14A, 14B, for example, at the surface that is opposite the variable cam surface 34A, 34B. In a non-limiting example, the engine assembly 10 includes one or more prime movers, designated generally at 60A and 60B in FIGS. 3 and 4, that are configured to selectively move the flywheels 14A, 14B longitudinally along the output shaft 30 to thereby selectively change the compression ratio of the internal combustion device 12. In the illustrated example, a first engine endwall 62A is adjacent the first flywheel 14A and a second engine endwall 62B is adjacent the second flywheel 14B. A tapered roller bearing and seat or bushing (not shown) in each endwall 62A, 62B can operatively attach the main shaft 30 the endwalls 62A, 62B. Each of the engine endwalls 62A, 62B defines a respective fluid cavity 64A and 64B within which is disposed a respective flywheel piston 66A and 66B, each of which may be a non-rotating annular plate. The flywheels 14A, 14B are buffered by a pressurized fluid (e.g., lubricant or air) between the flywheels 14A, 14B and flywheel pistons 66A, 66B. Alternately, the surfaces of the disk-shaped base 38A, 38B can be buffered with a thrust bearing. The outer edge of each flywheel piston 66A, 66B can be fluidly sealed by a polymeric O-ring or packing material that will allow it to move back and forth along the endwall 62A, 62B.

The introduction of additional pressurized fluid 68 into the fluid cavities 64A, 64B increases cavity pressure. In so doing, the flywheel pistons 66A, 66B are urged against the flywheels 14A, 14B thereby moving the flywheels 14A, 14B longitudinally along the output shaft 39 towards the internal combustion device 12, as seen in FIG. 3. Evacuating pressurized fluid 68 from the fluid cavities 64A, 64B decreases cavity pressure, whereby the flywheels 14A, 14B are allowed to transition away from the internal combustion device 12, as seen in FIG. 4. The pressure inside the fluid cavities 64A, 64B can be controlled, for example, by a smaller external piston (not shown) that is fluidly coupled to the cavity 64A, 64B. When this external piston is actuated, for example, via electrical or mechanical means, it creates or relieves pressure within the cavity 64A, 64B which in eventuality changes the CR, as explained above.

Alternatively, the cavities 64A, 64B could contain mechanical means to increase or decrease the force on the backside of the flywheel pistons 66A, 66B. For instance, a cam or series of cams positioned against the backside of the flywheel pistons 66A, 66B could be rotated or otherwise actuated, e.g., by external electric, hydraulic, mechanical or manual means, to move the pistons 66A, 66B. In other optional configurations, the cavities 64A, 64B could contain a worm gear or series of worm gears that operatively engage and move the flywheel pistons 66A, 66B. Gear movement could be effectuated by external electric, hydraulic, mechanical or manual means. The cavities 64A, 64B could alternatively contain a lever or series of levers that are attached by a pivot. Lever movement is actuated by external electric, hydraulic, mechanical or manual means.

Variations in engine operating conditions, such as engine and ambient temperatures, fuel mixture, rpm, engine load, and so forth, have an effect on the engine's efficiency. Often times, the best engine efficiency stems from consistent Stoichiometric combustion under any operating condition. The variable-compression engine assembly 10 disclosed herein provides the ability to change to any compression ratio necessary, e.g., at any time in the engine cycle—even during combustion if sensor feedback and flywheel movement is quick enough, to maintain a consistent Stoichiometric event. In so doing, the engine assembly 10 is more efficient than its conventional counterparts. Another potential benefit is that the engine assembly 10 can operate with a variety of different fuels. For example, the engine assembly 10 could run on gasoline at 10:1 and switch to diesel at 20:1 (in real time) or any other fuel thereof.

The overall operation of the engine assembly 10 can be understood by considering the illustrated configuration in use as a two-stroke engine. In this application, FIG. 3 or FIG. 4 could be considered to show pistons 18A, 18B at the “top” of their compression strokes. When the pistons 18A, 18B are at or near this “top” position, combustion inside the chamber 26 of the cylinder 16 drives the pistons 18A, 18B apart in power strokes to their “bottom” positions shown, for example, in FIG. 1. During the power stroke, the cam rollers 44A, 44B push against their respective variable cam surfaces 34A, 34B. The cam surfaces 34A, 34B, which are inclined relative to the axial thrust of the cam rollers 44A, 44B, react to the cam rollers 44A, 44B to rotate the flywheels 14A, 14B and, thus, the output shaft 30. In the power/exhaust stroke, combustion gas is exhausted through exhaust ports 22A, 22B. In the intake/compression stroke, air is forced into the cylinder 16 through air inlet port 20 by positive charging means, such as a compressor or supercharger (not shown). During the intake/compression stroke, the variable cam surfaces 34A, 34B press back against and drive the cam rollers 44A, 44B and pistons 18A, 18B away from the flywheels 14A, 14B. In other words, the cams 34A, 34B and rollers 44A, 44B can be said to be acting in the normal cam/follower relationship. During the power/exhaust stroke of the engine cycle, the relationship is inverted. The piston-driven cam rollers 44A, 44B act against the variable cam surfaces 34A, 34B to drive their respective flywheels 14A, 14B. (In spite of this inversion of functions during half of the engine cycle, it will nevertheless be convenient to consistently identify members 34A, 34B and members 44A, 44B as “cam surfaces” and “cam rollers,” respectively.)

Notwithstanding the foregoing description of the illustrated embodiment, it should be realized that the engine assembly 10 could also be structured with a single piston interacting with a single flywheel and corresponding variable cam surface. This configuration can, in effect, be illustrated by taking either side of FIG. 3 or 4 in isolation from the other. It could also be structured with single-piston chambers on opposite sides of a single flywheel with undulating cam surfaces on both sides of the flywheel. This configuration can also be illustrated by taking either side of FIG. 3 or 4 in isolation from the other as being an illustration of only one side of a flywheel with the other side being identical. It should also be realized that the engine assembly 10 could include more than two flywheels, each of which is rotated via one or more expansible chamber devices.

There are several advantages to be realized from the variable-compression engine assembly 10. For example, the engine assembly 10 does not include a traditional crankshaft or connecting rods, so the dynamic loads and stresses associated with such rapidly accelerating, decelerating, rotating, and reciprocating members are eliminated. Fewer rotating and reciprocating parts also reduces friction losses. The engine assembly 10 is also lighter in weight because of fewer components, and because reduced internal antagonistic forces allow for lighter construction. Other advantages stem from the variable cam surface configurations, which can be designed to vary or control numerous engine parameters, for example, by varying piston movement. In a non-limiting example, the amplitude of the wave pattern can be increased or decreased to increase/decrease the structural compression ratio (and piston travel/stroke).

Numerous variations to the cam surfaces are possible that can alter the structural compression ratios, duration of intake/exhaust stroke, duration of combustion/power stroke, compression stroke pattern (to maximize cylinder fill volumetric efficiency), and power stroke pattern to maximize transfer of power from piston to flywheel. Overall, the amplitude of a stroke is based on crest to trough amplitude, while the length of time allowed for any event in the engine cycle is related to the slope of the portion of the undulating surface corresponding to the event. A steeper slope dictates a shorter time, while a flatter or flat slope extends the time. The aforesaid ability to freely vary, shape and determine various engine performance parameters stands in stark contrast to conventional crankshaft-piston-connecting rod assemblies. In these assemblies, rotational duration is fixed by the radius of the crankshaft, and piston TDC and BDC duration can be only minimally altered by use of connecting rods of different lengths.

The expansible chamber itself can also be designed and configured to enhance certain characteristics. As previously noted, the expansible chamber engine configuration reduces the weight of the reciprocating assemblies by eliminating connecting rods, a crankshaft, and counterweights, and with fewer cylinders for a given number of power strokes per flywheel revolution. As the tops of the two pistons form the combustion chamber at their top dead center, there is enormous flexibility in designing the shape of the combustion chamber for complete and efficient combustion, flame propagation, and maximum combustion pressure. Intake and exhaust ports can also be located to enhance the discharge of exhaust gas, influx of incoming air, and tumbling and turbulence within the cylinder. Additional advantages and alternatives are disclosed in commonly owned U.S. Pat. No. 7,040,262, to Patrick C. Ho, which is incorporated herein by reference.

While exemplary embodiments and applications of the present disclosure have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

1. An engine assembly comprising:
an output shaft;
a flywheel with a variable cam surface, the flywheel being slidably mounted onto the output shaft and rotatable about a flywheel axis; and
an internal combustion device with a piston movable along a central axis in a cycle between retracted and extended positions, the piston engaging the variable cam surface, and the central axis of the piston being spaced from the flywheel axis,
wherein the cycle includes a power stroke when the piston moves from the retracted position to the extended position whereby the piston presses against the variable cam surface and thereby rotates the flywheel, and a compression stroke when the piston moves from the extended position to the retracted position responsive to the variable cam surface.

2. The engine assembly of claim 1, wherein the flywheel is configured to slide longitudinally along the output shaft and thereby change a compression ratio of the internal combustion device.

3. The engine assembly of claim 2, wherein the flywheel is slidable between first and second longitudinal positions on the output shaft, the internal combustion device having a first compression ratio when the flywheel is located at the first longitudinal position and a second compression ratio when the flywheel is located at the second longitudinal position.

4. The engine assembly of claim 1, further comprising a prime mover configured to move the flywheel longitudinally along the output shaft and thereby selectively change a compression ratio of the internal combustion device.

5. The engine assembly of claim 1, further comprising an engine endwall adjacent the flywheel, the engine endwall defining a fluid cavity within which is disposed a flywheel piston, wherein the introduction of pressurized fluid into the fluid cavity urges the flywheel piston against the flywheel thereby moving the flywheel longitudinally along the output shaft.

6. The engine assembly of claim 1, wherein the output shaft is splined or keyed, or both, to the flywheel.

7. The engine assembly of claim 1, wherein the flywheel rotates at least approximately 360 degrees during the cycle.

8. The engine assembly of claim 1, wherein the flywheel includes an annular rim projecting from a disk-shaped base, the variable cam surface extending continuously around an edge of the annular rim.

9. The engine assembly of claim 8, wherein the annular rim has a variable height providing the variable cam surface with a single peak and a single valley.

10. The engine assembly of claim 1, wherein the internal combustion device further comprises a cam roller attached to an outboard end of the piston, the cam roller engaging the piston with the variable cam surface of the flywheel.

11. The engine assembly of claim 1, wherein at least a portion of the variable cam surface is configured to control an engine parameter, the engine parameter including a compression ratio, a duration of intake stroke, a duration of exhaust stroke, a duration of combustion stroke, a duration of power stroke, a compression stroke pattern, a volumetric efficiency, or a power stroke pattern, or any combination thereof.

12. The engine assembly of claim 1, wherein an amplitude of at least a portion of the variable cam surface is selected to control an engine parameter of the internal combustion device.

13. The engine assembly of claim 1, wherein an arc length of at least a portion of the variable cam surface is selected to control an engine parameter of the internal combustion device.

14. A variable-compression engine assembly comprising:
an output shaft rotatable about a common axis;
a flywheel with a variable cam surface, the flywheel being mounted onto the output shaft for common rotation therewith, the flywheel being rotatable about the common axis and selectively slidable on the output shaft along the common axis;
an internal combustion device with a piston disposed in a cylinder, the piston being movable along a central axis in a cycle between retracted and extended positions, an outboard end of the piston engaging the variable cam surface, and the central axis of the piston being radially spaced from the common axis; and
a prime mover configured to move the flywheel longitudinally along the output shaft to thereby selectively change a compression ratio of the internal combustion device,
wherein the cycle includes a power stroke when the piston moves from the retracted position to the extended position whereby the piston presses against the variable cam surface and thereby rotates the flywheel, and a compression stroke when the piston is moved by the flywheel from the extended position to the retracted position responsive to the variable cam surface.

15. An engine assembly comprising:
an output shaft rotatable about a common axis;
a first flywheel with a first variable cam surface, the first flywheel being slidably mounted onto the output shaft and rotatable about the common axis;
a second flywheel coaxial with and spaced from the first flywheel, the second flywheel having a second variable cam surface facing the first variable cam surface, the second flywheel being mounted onto the output shaft and rotatable about the common axis; and
an internal combustion device disposed between the first and second flywheels, the internal combustion device having first and second opposing pistons each being movable along a central axis in a cycle between respective retracted and extended positions, the central axis of the pistons being spaced from the common axis of the output shaft and flywheels, the first piston engaging the first variable cam surface and the second piston engaging the second variable cam surface,
wherein each cycle includes a power stroke, whereat a respective one of the pistons moves from respective retracted to extended positions whereby the respective piston presses against a respective one of the variable cam surfaces and thereby rotates a respective one of the flywheels, and a compression stroke, whereat the respective piston moves from respective extended to retracted positions responsive to the respective variable cam surface.

16. The engine assembly of claim 15, further comprising a prime mover configured to move the first flywheel longitudinally along the output shaft to thereby selectively change a compression ratio of the internal combustion device.

17. The engine assembly of claim 15, wherein the second flywheel is selectively slidable on the output shaft along the common axis.

18. The engine assembly of claim 15, wherein the first and second flywheels are both mounted onto the output shaft for common rotation therewith.

19. The engine assembly of claim 15, wherein the first and second opposing pistons are disposed inside a cylinder such that the pistons define a combustion chamber therebetween.

20. The engine assembly of claim 15, wherein the output shaft includes a first output shaft and a second output shaft, the first flywheel being mounted onto the first output shaft and the second flywheel being mounted onto the second output shaft, the first and second output shafts being operatively connected together by a gear mechanism.
